(19) United States
(12) Patent Application Publication
(10) Pub. No.: US 2024/0328076 A1
(43) Pub. Date: Oct. 3, 2024

(54) ACTIVE SELF-TRANSFORMABLE TEXTILES

(71) Applicant: Massachusetts Institute of Technology, Cambridge, MA (US)

(72) Inventors: Skylar JE Tibbits, Boston, MA (US); Athina Papadopoulou, Cambridge, MA (US); Christophe Guberan, La Praz (CH)

(21) Appl. No.: 18/592,083

(22) Filed: Feb. 29, 2024

Related U.S. Application Data
(62) Division of application No. 15/161,770, filed on May 23, 2016, now abandoned.
(60) Provisional application No. 62/165,425, filed on May 22, 2015.

(51) Int. Cl. D06M 15/19; B32B 3/10; B32B 5/02; B32B 5/18; B32B 7/12; B32B 9/02; B32B 25/00; B32B 27/12; B32B 27/30; B32B 27/32; B32B 27/36; D06M 15/227; D06M 15/256; D06M 15/507; D06M 23/16; D06Q 1/00; D06Q 1/08

(52) U.S. Cl. CPC D06M 15/19; B32B 3/10; B32B 5/02; B32B 5/024; B32B 5/026; B32B 5/18; B32B 7/12; B32B 9/025; B32B 25/00; B32B 27/12; B32B 27/304; B32B 27/32; B32B 27/36; D06M 15/227; D06M 15/256; D06M 15/507; D06M 23/16; D06Q 1/00; D06Q 1/08; B32B 2262/0207; B32B 2262/0215; B32B 2262/023; B32B 2262/0276; B32B 2262/0292; B32B 2262/062; B32B 2262/08; B32B 2270/00; B32B 2307/546; B32B 2307/732; B32B 2307/75; B32B 2437/00; B32B 2601/00; B32B 2605/003

(57) ABSTRACT

A method of forming an active self-transformable material includes providing a flexible base material and disposing an active material on one or more surfaces of the flexible base material or within the flexible base material in a specific pattern to form a combined structure having a natural shape, wherein the active material is a material that is reactive to exposure to an external stimulus trigger, wherein the flexible base material is non-reactive to the external stimulus trigger, minimally reactive to the external stimulus trigger, or reactive to the external stimulus trigger differently than the active material, and wherein exposure of at least a portion of the specific pattern of the active material to the external stimulus trigger changes the shape of the combined structure from the natural shape into a predetermined 3-dimensional transformed shape.

### RELATED APPLICATION(S)

This application is a divisional of U.S. Non-Provisional application Ser. No. 15/161,770, filed on May 23, 2016, which claims the benefit of Provisional Application No. 62/165,425, filed on May 22, 2015. The entire teaching of each of the above applications is incorporated herein by reference.

### FIELD OF THE INVENTION

The present invention relates to active self-transformable materials. More particularly, the present invention relates to a method for creating self-transformable materials by printing, laminating, or otherwise disposing one or more active materials onto and/or within a flexible base material to promote precise shape transformations upon exposure of the active self-transformable material to an external stimulus.

### BACKGROUND OF THE INVENTION

Many industries require precisely shaped materials to meet aesthetic and/or functional needs. While current manual and automated methods and technologies may possibly meet these needs to some extent, these methods and technologies are often complex, require significant energy, precision and skill, and require expensive tools and machinery to produce the desired intricate shapes. In addition, current manufacturing technologies generally provide a static product. In particular, current methods and technologies typically involve the formation of parts and other components having a fixed shape, and those individual components are then assembled into more complex structures also having a fixed shape. Thus, most products found in the marketplace take on a single form, and that form does not change or adapt. In view of these limitations, improvements are needed in the design and manufacture of 3-dimensional shaped products in many industries. In addition, it would be desirable to provide materials, clothing, footwear, and other goods that are highly active rather than static, so as to provide enhanced performance (e.g., breathability, moisture control, temp control, dynamic compression, etc.).

For example, in sports and physical fitness, complex 3D structures for sportswear and equipment are required from a performance and aesthetic perspective. In addition, sportswear and equipment that has a more customized fit and which can provide compression, constraint, and/or protection where needed are in demand. In the related world of fashion design, intricate patterns using pleating and complex stitching details are often utilized. When designing clothing, footwear and other accessories, the materials must be formed into shapes having a complex curvature to provide a variety of wearers with a proper fit. In particular, footwear and leather goods are examples of products that rely on industrial forming techniques to stretch and force materials around a physical mold to achieve a complex curvature. The physical mold imposes constraints on the possible number and complexity of the end product given that a new mold is needed for each unique product. These molds tend to be expensive, static and simple due to their manufacture, which typically uses CNC-machining.

Interior design involves furniture and other products that typically require manual assembly, molding, pleating, tufting, knotting, complex stitching, and other intricate detailing processes. Further, textile-based complex and 3-dimensional interior partitions and other wall treatments are commonly used. Manufacture of these goods often requires manual or automated skilled and precise control for production, which increases the time and energy needed to produce each item. This further drives up the price of these products, relegating highly detailed products to high-end markets or hand-craft couture spaces.

In the medical and health fields, compression garments with various degrees of compression and tension across the body are needed to help circulate blood flow in custom pathways and to provide support.

Thus, it would be desirable to provide new materials and methods which make it possible to more easily provide currently manufactured complex 3D shaped materials, and to provide 3D shaped materials that have not been previously attainable. In addition customization of the manufactured 3D shapes, without increasing or the complexity, skill, and time for producing custom products would be highly desirable.

In addition, nearly every industry has long desired smarter materials and robotic-like transformation—from apparel, architecture, product design and manufacturing, to aerospace and automotive industries. However, these capabilities have often required expensive, error-prone and complex electromechanical devices (e.g., motors, sensors, electronics), bulky components, power consumption (e.g., batteries or electricity) and difficult assembly processes. These constraints have made it challenging to efficiently produce dynamic systems, higher-performing machines and more adaptive products.

Further, while “smart” materials have been developed, which can provide some sort of a dynamic structure, such materials are often formed in fixed shapes and sizes. These materials must subsequently be assembled into the necessary end product form, typically using off the shelf (non-custom) parameters. These types of smart materials are extremely expensive and are generally only found in niche markets due to their cost. Further, using these smart materials to provide a specific type of product having a particular shape requires significant skill and time.

Thus, it would be desirable to provide new materials and methods which make it possible to more easily provide currently manufactured complex 3D shaped materials, and to provide 3D shaped materials that have not been previously attainable. Further, it would be desirable to provide such materials which are further capable of dynamically changing their shape on demand, particularly in response to an external trigger.

### SUMMARY OF THE INVENTION

Embodiments of the present invention provide a novel materiel, method of manufacture, and complex 3-dimensional structures and active structures formed therefrom.

According to one aspect, the present invention provides an active self-transformable material comprising a flexible base material, and an active material disposed on the flexible base material in a predetermined pattern to form a combined structure, the combined structure having a natural shape. In particular, the active material is reactive to an external stimulus trigger, and the flexible base material is non-reactive to the external stimulus trigger, minimally reactive to the external stimulus trigger, or reactive to the external stimulus trigger differently than the active material, wherein exposure of at least a portion of the predetermined pattern of the active material to the external stimulus trigger changes the shape of the combined structure from the natural shape into a predetermined 3-dimensional transformed shape.

According to various embodiments, the material can comprise one or more of the following features. The natural shape of the combined structure is a shape of the combined structure absent an external stimulus trigger. The flexible base material is selected from stretchable and non-stretchable textiles, elastomeric materials, plastics, rubber, leather, animal skin materials, vegan alternatives to animal skin materials, and sheet foam. The flexible base material is a textile selected from the group consisting of cotton, neoprene, jersey, vinyl, velvet, brocade, silk, polyesters, wool, linen, mesh, and polyester-polyurethane copolymers, including elastane, and spandex. The active material is a material activated by exposure to temperature change, exposure to light change, exposure to solvents, exposure to moisture, exposure to energy, including electrical energy, exposure to infrared light, exposure to visible light, and exposure to ultraviolet light. The active material is a material selected from hydrogels, plastics, polyethylene (PE), polyethylene terephthalate (PET), polyvinylidene fluoride (PVDF), thermoplastic polymers, and combinations thereof. The active material is reactive to the external stimulus trigger by swelling or shrinking. The active material has a thermal expansion modulus that causes the active material to shrink or swell upon exposure to a temperature change. The change in the shape of the combined structure from the natural shape into a predetermined 3-dimensional transformed shape is a reversible change. The change in the shape of the combined structure from the natural shape into a predetermined 3-dimensional transformed shape is an irreversible change. The flexible base material is in the form of a generally flat and flexible material having a plurality of flaps disposed therein, wherein the active material is disposed on the plurality of flaps in such a manner that exposing the active material to the external stimulus trigger causes the flaps to lift and form a plurality of air vents.

According to another aspect, the present invention provides a method of forming an active self-transformable material comprising providing a flexible base material, and disposing an active material on one or more surfaces of the flexible base material or within the flexible base material in a specific pattern to form a combined structure having a natural shape, wherein the active material is a material that is reactive to exposure to an external stimulus trigger, wherein the flexible base material is non-reactive to the external stimulus trigger, minimally reactive to the external stimulus trigger, or reactive to the external stimulus trigger differently than the active material, and wherein exposure of at least a portion of the specific pattern of the active material to the external stimulus trigger changes the shape of the combined structure from the natural shape into a predetermined 3-dimensional transformed shape.

According to various embodiments, the method can comprise one or more of the following features. The natural shape of the combined structure is a shape of the combined structure absent exposure to the external stimulus trigger. Disposing the specific pattern of the active material onto the flexible base material comprises 3D printing the active material, laminating or adhering the specific pattern of the active material to flexible base material, or knitting, weaving, stitching, or injecting the active material in the predetermined pattern onto or within the flexible base material. The specific pattern further includes particular heights and widths of the active material along the pattern. The method further comprises tailoring one or more properties of the flexible base material and the active material to achieve the predetermined transformed 3-dimensional shape, the one or more properties being selected from a composition of the flexible base material, composition of the active material, a particular shape of the flexible base material, a thickness of the flexible base material, a stiffness of the flexible base material, a flexibility of the flexible base material, a directionality of the flexible base material, a thickness of the flexible base material, a thickness pattern of the active material, a width pattern of the active material, an overall design pattern of the active material, an amount of the active material, and a difference between one or more properties of flexible base material and the active material. The external stimulus trigger is selected from one or more solvents, a temperature change, energy, a pressure change, a lighting change, moisture infrared light, visible light, and ultraviolet light, and combinations thereof. The flexible base material is a material selected from stretchable and non-stretchable textiles, elastomeric materials, plastics, rubber, leather, animal skin materials, vegan alternatives to animal skin materials, and sheet foam. The flexible base material is a stretchable or non-stretchable textile selected from the group consisting of cotton, neoprene, jersey, vinyl, velvet, brocade, silk, polyesters, wool, linen, mesh, and polyester-polyurethane copolymers, including elastane, and spandex. The active material is a material selected from materials activated by exposure to temperature change, exposure to light change, exposure to solvents, exposure to moisture, exposure to energy, including electrical energy, exposure to infrared light, exposure to visible light, and exposure to ultraviolet light. The active material is a material selected from hydrogels, plastics, polyethylene (PE), polyethylene terephthalate (PET), polyvinylidene fluoride (PVDF), thermoplastic polymers, and combinations thereof. The active material is reactive to the external stimulus trigger by swelling or shrinking. The active material has a thermal expansion modulus that causes the active material to shrink or swell upon exposure to a temperature change. The change in the shape of the combined structure from the natural shape into the predetermined 3-dimensional transformed shape is a partially or fully reversible change. The change in the shape of the combined structure from the natural shape into the predetermined 3-dimensional transformed shape is an irreversible change.

According to another aspect, the present invention provides a method of forming a predetermined 3-dimensional manufactured shape comprising providing a flexible base material, disposing an active material on one or more surfaces of the flexible base material or within the flexible base material in a specific pattern to form a combined structure having a natural shape, wherein the active material is a material that is reactive to exposure to an external stimulus trigger, and wherein the flexible base material is non-reactive to the external stimulus trigger, minimally reactive to the external stimulus trigger, or reactive to the external stimulus trigger differently than the active material, and exposing at least a portion of the specific pattern of the active material to the external stimulus trigger to cause a change in the shape of the combined structure from the natural shape into the predetermined 3-dimensional manufactured shape.

According to various embodiments, the method can include one or more of the following features. Exposing at least a portion of the specific pattern of the active material to the external stimulus trigger comprises exposing only a portion of the specific pattern to the external stimulus trigger to achieve a localized change in the shape of the combined structure. Disposing the specific pattern of the active material onto the flexible base material comprises 3D printing the active material, laminating or adhering the specific pattern of the active material to flexible base material, or knitting, weaving, stitching, or injecting the active material in the predetermined pattern onto or within the flexible base material. The method further comprises tailoring one or more properties of the flexible base material and the active material to achieve the predetermined transformed 3-dimensional shape, the one or more properties being selected from a composition of the flexible base material, composition of the active material, a particular shape of the flexible base material, a thickness of the flexible base material, a stiffness of the flexible base material, a flexibility of the flexible base material, a directionality of the flexible base material, a thickness of the flexible base material, a thickness pattern of the active material, a width pattern of the active material, an overall design pattern of the active material, an amount of the active material, and a difference between one or more properties of flexible base material and the active material. The external stimulus trigger is selected from one or more solvents, a temperature change, energy, a pressure change, a lighting change, moisture infrared light, visible light, and ultraviolet light, and combinations thereof. The flexible base material is a material selected from stretchable and non-stretchable textiles, elastomeric materials, plastics, rubber, leather, animal skin materials, vegan alternatives to animal skin materials, and sheet foam. The flexible base material is a stretchable or non-stretchable textile selected from the group consisting of cotton, neoprene, jersey, vinyl, velvet, brocade, silk, polyesters, wool, linen, mesh, and polyester-polyurethane copolymers, including elastane, and spandex. The active material is a material selected from materials activated by exposure to temperature change, exposure to light change, exposure to solvents, exposure to moisture, exposure to energy, including electrical energy, exposure to infrared light, exposure to visible light, and exposure to ultraviolet light. The active material is a material selected from hydrogels, plastics, polyethylene (PE), polyethylene terephthalate (PET), polyvinylidene fluoride (PVDF), thermoplastic polymers, and combinations thereof. The active material is reactive to the external stimulus trigger by swelling or shrinking. The active material has a thermal expansion modulus that causes the active material to shrink or swell upon exposure to a temperature change. The change in the shape of the combined structure from the natural shape into the predetermined 3-dimensional transformed shape is a partially or fully reversible change. The change in the shape of the combined structure from the natural shape into the predetermined 3-dimensional transformed shape is an irreversible change. The method further comprises, before exposing at least a portion of the specific pattern of the active material to the external stimulus trigger forming the combined structure having a natural shape into a first 3-dimensional structure, wherein subsequent exposing at least a portion of the specific pattern of the active material to the external stimulus trigger causes a change in natural shape of the combined structure forming the first 3-dimensional structure into the predetermined 3-dimensional manufactured shape. The flexible base material is in the form of a generally flat and flexible material having a plurality of flaps disposed therein, wherein the active material is disposed on the plurality of flaps in such a manner that exposing the active material to the external stimulus trigger causes the flaps to lift and form a plurality of air vents, and wherein the predetermined 3-dimensional manufactured shape is the first 3-dimensional structure with the plurality of air vents in a lifted position. The external stimulus trigger is a temperature change.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principals of the invention.

FIGS. 1A-1C illustrate deposition of an active material onto a flexible base material, subsequent application of a trigger, and a resultant 3-dimensional transformed structure of the combined flexible base material/active material according to an embodiment of the present invention.

FIGS. 2A-2B illustrate a method of 3D printing an active material onto a flexible base material according to an embodiment of the present invention.

FIGS. 3A-C illustrate a method of laminating an active material onto a flexible base material according to an embodiment of the present invention.

FIGS. 4A-4C illustrate different types of activation energies according to embodiments of the present invention.

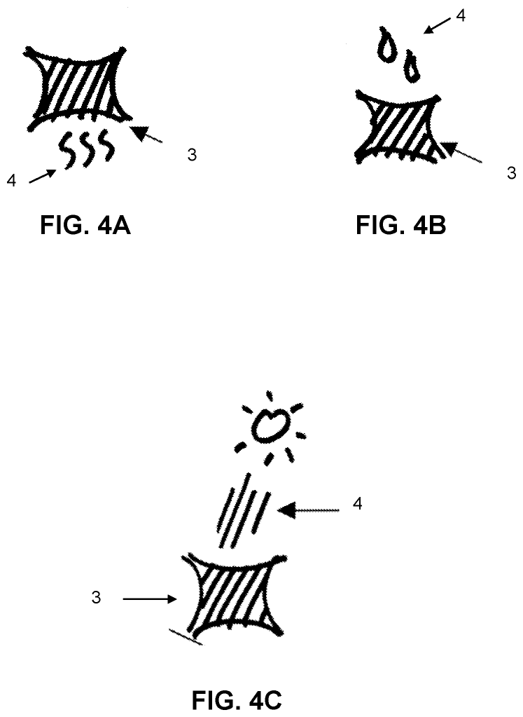

FIGS. 5A-5D illustrate a self-transforming material comprising a flexible base material and an active material disposed thereon, wherein activation of a trigger results in a ventilating material according to an embodiment of the present invention.

### DETAILED DESCRIPTION

The following definitions are useful for interpreting terms applied to features of the embodiments disclosed herein, and are meant only to define elements within the disclosure.

As used herein, the term “manufactured shape” or “transformed shape” refers to a predetermined geometrical shape. For example, according to the present invention, a manufactured or transformed shape is different than a shape that would occur in the flexible base material absent application of the active material, upon application of the active material in an uncontrolled manner, or absent exposure of the combined structure (i.e., the flexible base material plus the active material) to a trigger that activates the active material. In other words, a shape that is not a predetermined shape is not a manufactured or transformed shape. It should be understood that the term “predetermined” does not mean that every parameter, such as volume, angle, stiffness, etc., is known in advance, but rather that a shape is considered to be a manufactured shape if it is generally predicted at the time of producing the object. Depending upon the type of transformation, the actual transformed shape may differ from the predetermined shape by about ±5%, ±10%, ±30%, or ±50%.

As used herein, the term “self-transforming material” or “transformable material” refers to a material that is present in a first shape, and which, upon exposure of the material to one or more triggers, changes shape. The shape into which the material changes is a predetermined manufactured or transformed shape. The self-transforming material or transformable material may be one which changes shape reversibly or irreversibly (permanently), and a single time or repeatedly. For example, the shape of the material may change to the transformed shape upon exposure to a trigger, and may then change back to the original shape upon removal of the trigger, reversal of the trigger or exposure to a suitable different trigger (i.e., heating to transform and then cooling to reverse, temperature change to transform and light change to reverse, etc.). In addition, the shape of the material may change to the transformed shape upon exposure to a trigger, and may then change to another second transformed shape upon exposure to a second different trigger, and may then change back to the original shape upon removal of the second trigger, reversal of the trigger or exposure to a suitable different trigger.

As used herein, the term “combined structure” includes the stretchable base material with the one or more active materials disposed on or within the stretchable base material. The combined structure is a self-transforming material/transformable material.

As used within this disclosure, a “flexible base material”, which may also be referred to as a “flexible substrate material”, refers to any material that does not react to the trigger or that reacts to the trigger in a different way than the active material reacts. The flexible base material must be a material onto or into which one or more active materials may be disposed, such as by 3D printing, lamination, adhesion, or other additive manufacturing methods. The “flexibility” of the flexible base material may either be global or localized. In particular, a global flexibility would generally be provided by a material that has an overall flexibility, typically due to the nature of the material. On the other hand, a localized flexibility would generally be provided by a material that has an overall stiffness, typically due to the nature of the material, but which has one or more hinges or bendable/flexible portions which allow the material to flex along the one or more hinges. Such hinges are typically provided along one or more lines within the material, which are fabricated so as to allow the material to bend or flex along the one or more lines. The flexible base material may also be stretchable, but it is not necessary for the flexible base material to be stretchable. Such flexible base materials do not include composite materials. “Composite materials”, as used herein, refer to materials impregnated with a resin, such as, for example, carbon fiber, glass fiber, Kevlar, fiberglass, and basalt fiber, and crystal polymers.

As used within this disclosure, a “textile” refers to a type of stretchable base material, and includes woven, knitted, braided, crocheted, felted, and knotted materials formed from natural and/or artificial fibers.

As used within this disclosure, an “active material” refers to a material that is activated by exposure to one or more triggers. In particular, activation of the active material results in a change in one or more properties of the active material. More particularly, one or more properties of the active material change upon exposure to a trigger such that the shape of the active material changes in some way (e.g., by swelling, shrinking, expanding, bending, folding, twisting, etc.). The active material is a material that may be disposed on or within the flexible base material.

The present invention generally provides a flexible base material with one or more active materials disposed on one or more surfaces or incorporated within the flexible base material to form a combined structure. The combined structure is a transformable material that automatically transforms shape in response to exposure to one or more triggers. The present invention further generally provides a method of forming such transformable materials by printing, laminating, adhering, or otherwise disposing one or more active materials on or within one or more surfaces of a flexible base material to thereby form a combined structure. The combined structure has a natural shape absent exposure to the one or more specific triggers. The one or more active materials are selected to respond to the one or more specific triggers such that, upon exposure to the one or more specific triggers, combined structure transforms in shape. The present invention further generally provides complex structures formed using the transformable materials.

Reference will now be made in detail to embodiments of the present invention, examples of which are illustrated in the accompanying drawings. Wherever possible, the same reference numbers are used in the drawings and the description to refer to the same or like parts.

According to one aspect, the present invention provides a flexible base material 1 with one or more active materials 2 disposed thereon or therein to form a combined structure 3, which is a transformable material.

The flexible base material 1 generally has a natural state that is typically a flat 2-dimensional shape when resting on a surface. The flexible base materials 1 may vary in flexibility, with some materials providing more structure to their shape than others. For example, some flexible base materials will generally take on the shape of a surface they are placed upon (e.g., will be flat when placed on a flat table, and will form a concave shape when placed along the curvature of a bowl or other concave structure). Other materials will generally maintain some of their internal shape to some extent, while partially taking on a shape they are placed upon (e.g., a thick, stiff wool which will be flat when placed on a flat table, and may curve somewhat along the curvature of a concave structure, but may also maintain some if it's internal flat structure).

The material usable as the flexible base material 1 is not particularly limited provided that it is a material that is different than the particular active materials 2 that are used. In particular, the flexible base material 1 is a material that, when exposed to one or more active material triggers 4, is not itself activated (i.e., does not change shape or properties), is minimally or undetectably activated, or is activated in a manner different than the manner in which the active materials 2 are activated. The flexible base material 1 is one that has enough flexibility such that, upon exposure of the combined structure 3 to one or more active material triggers 4, it allows the active material 2 to change its shape so as to provide the transformed shape 5. Some examples of the flexible base material 1 include, but are not limited to textiles, elastomeric materials, plastics, rubber, leather, animal skin materials, vegan alternatives to animal skin materials, and sheet foam. Such materials may be stretchable or non-stretchable and, if stretchable, may be elastically/reversibly stretchable.

The flexible base material 1 is typically any conventional flexible (either globally or locally flexible) material that is used in industries such as the clothing, footwear, interior design/furniture, building, aviation, and automotive industries. These materials are generally in the form of a 2-dimensional sheet of the material (e.g., a piece of fabric), although it is also possible to use what may be considered a 3-dimensional sheet of material, which is a material having an added dimension of thickness (particularly in the mm to cm scale thickness). Some examples of suitable textiles include, but are not limited to, cotton, polyester-polyurethane copolymers (e.g., Lycra®, elastane, and spandex), neoprene, jersey, vinyl, velvet, brocade, silk, polyesters, wool, linen, mesh, and other common stretchable and non-stretchable materials used in forming clothing, accessories and footwear. In addition, materials such as leather and suede, as well as their vegan alternatives, can be used as the flexible base material 1. The flexible base material 1 is beneficially a material that does not require disposing the or more active materials 2 thereon or therein in any particular orientation relative to a grain pattern, weave pattern, or knit pattern of the fibers of the flexible base material 1 in order to provide the transformed shape.

The active material 2 is a material that is deposited on the flexible base material 1 in a predetermined and specific shape. The shape is specifically designed and deposited on the flexible base material 1 so as to provide a combined structure 3 that will take on a transformed shape 5 when the combined structure 3 is exposed to one or more active material trigger 4. It is noted that since it is the active material 2 that is activated by the active material trigger 4, the entire combined structure 3 need not be exposed to the active material trigger 4. Rather, it is only necessary for the active material 2 to be exposed to the active material trigger 4 either directly or indirectly. Further, as discussed further herein, only a portion of the active material 2 can be exposed to the active material trigger 4 to achieve activation of only some of the active material 2, if desired.

The active material 2 can be deposited on the flexible base material 1 using any method that allows for precise deposition of the active material 2 in a desired pattern onto the flexible base material 1.

Some examples of active materials 2 usable in forming the combined structure 3 according to the present invention include, but are not limited to, materials activated by exposure to temperature change, exposure to light change, exposure to solvents, exposure to various other forms of energy (e.g., electrical energy, such as within the infrared, visible, ultraviolet, or other portion of the electromagnetic spectrum). More particularly, the active materials 2 can include, but are not limited to materials which are triggered by exposure to polar solvents, such as water, alcohols, and combinations thereof, hydrogels which are triggered by moisture change, nylon and other plastics which are triggered by temperature change, polystyrene and other plastics which are triggered by light-based change. In addition, a variety of polymers are suitable for use as the active materials 2. For example, polyethylene (PE), (including high density polyethylene (HDPE), low density polyethylene (LDPE)), polyethylene terephthalate (PET), polyvinylidene fluoride (PVDF), and any variety of thermoplastic polymers.

According to some embodiments, the active material 2 is in the form of a heat activated material that is painted or dyed a dark material (as opposed to the surrounding/other materials), particularly dyed black. It is known that dark colors, particularly black, absorb light and heat faster and more than other colors. Thus, by providing one or more portions of the flexible base material 1 with one or more heat activated portions that are black in color in contrast to surrounding colors, a subsequent application of heat by, for example, direct thermal radiation, IR light, UV light, etc. will cause the black color to heat up the underlying material specifically in those portions on which the black color is provided. This dying or painting technique could beneficially be used, for example, to provide activation along a flexible base material 1, wherein activation is caused to a greater extent in some locations (the dyed/painted locations) than in the other locations.

Similar targeting of portions of the flexible base material 1 to transform to a greater extent than other portions can also be provided by disposing different types of active materials 2 having varying degrees of reactivity to a trigger 4, or disposing one type of active material 2 in varying amounts on the flexible base material (wherein a thicker deposition layer of active material 2 will generally result in a greater force of reaction, but the thicker deposition layer of active material 2 will have more stiffness. As such, this thicker deposition will generally result in a faster transformation—due to the greater force—that is less pronounced—due to the greater degree of stiffness—than a thinner deposition). In a similar manner, the transformation can be tailored so that some portions of the flexible base material 1 will transform faster than other portions. This can be based on the same concepts above, in which different active materials 2 of different reactivity and/or different amounts of active materials 2 are disposed in various portions.

According to various embodiments, the active material 2 is selected to respond to a specific trigger 4 based on the end application. For example, the transformable material may be used to form a product, such as clothing or footwear, that will transform as a result of exposure of the clothing or footwear to temperature change (e.g., upon increase of body temperature or external temperature), pressure change (e.g., upon swelling of a body part or foot), moisture change (e.g., upon sweating), or even light-based change (e.g., upon a change in daylight or exposure to ambient lighting indoors).

The resultant 3-dimensional shape transformation in any situation can be the result of various properties of both the flexible base material 1 and the active material 2. As such, in designing a combined structure 3, one may take into consideration any one or more of the various properties of each of the materials. Some possible properties that can be taken into consideration in designing the combined structure 3 include, but are not limited to, the type of flexible base material 1, the thickness of the flexible base material 1, the flexibility of the flexible base material 1, the directionality of the flexible base material, the type of active material 2, the pattern of active material 2, the amount of active material 2, and the difference in properties between the flexible base material 1 and the active material 2. In addition a plurality of active materials 2 of different type may be disposed on the flexible base material 1 such that the properties of the plurality of active materials, in combination, provide further tailoring of the resultant 3-dimensional shape transformation.

According to some embodiments, one may choose to select and maintain all but one property constant when selecting the flexible base material 1 and active material 2, while varying the one non-constant property in order to achieve a particular transformation. Alternatively, multiple properties may be modified and selected, as needed, to achieve a particular transformation.

For example, the composition and characteristics of the selected flexible base material 1 plays an important role in the behavior of the combined structure 3 (e.g., breathability, flexibility, waterproofing, etc.), the adhesion of the one or more active materials 2, and the ultimate physical transformation of the combined structure 3. Thus, any one or more of the particular characteristics of various materials usable as the flexible base material 1 can be taken into consideration, as desired, to achieve a particular predetermined transformed shape 5.

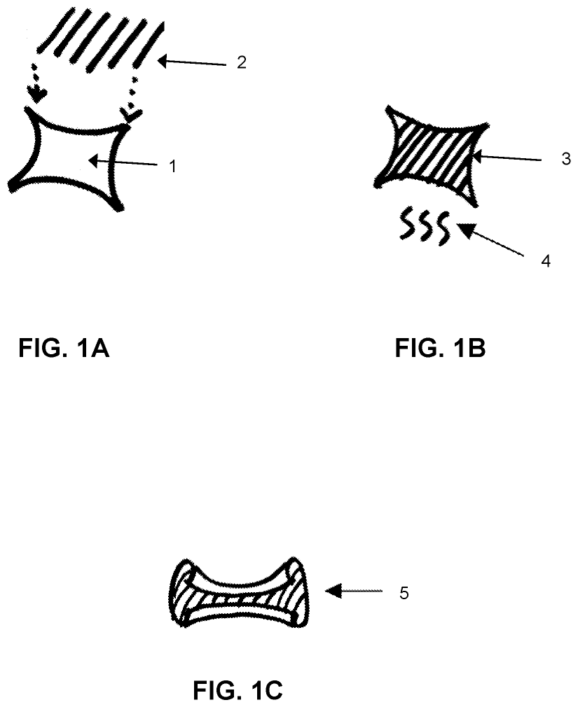

Each material usable as a flexible base material may have unique characteristics of directionality and flexibility, which are capable of promoting or constraining transformation of the combined structure 3 into the transformed shape 5. For example, one simple implementation is illustrated in FIGS. 1A-1C, which comprises a flexible, non-stretch flexible base material 1 with an active material 2 (activated by heat so as to shrink) disposed on one side of the flexible base material 1. As the combined structure 3 is exposed to heat FIG. 1B, the active material 2 shrinks. This causes the flexible base material 1 to curl together with the active material 2 on the inside of the curve and the flexible base material 1 on the outside, as illustrated in FIG. 1C.

With respect to directionality of the flexible base material 1, the warp versus weft of the flexible base material 1 may have a directional preference, greater resistance strength, or greater flexibility in one axis than the other.

The active material 2 generally includes one or more materials that are printed, laminated, adhered or otherwise applied or disposed in a particular pattern onto/within the flexible base material 1. The particular pattern is designed so as to cause the flexible base material 1 to geometrically transform (e.g., by curling, folding, stretching, shrinking, creasing, curved creasing, and the like) into a desired precise and predetermined transformed shape 5 upon exposure of the active material 2 to one or more active material triggers 4. These active materials 2 are generally disposed on the flexible base material so as to remain thereon and so that the combined structure 3 will act like a single system and will transform into the desired precise and predetermined transformed shape 5.

Design of the active material pattern 2 can be varied in light of the characteristics of the flexible base material 1. For example, depending upon the flexibility and/or directionality of the flexible base material 1, the thickness (i.e., height), width, and/or pattern of the active material 2 can be tailored so as to achieve a precise transformed structure. Alternatively, the thickness (i.e., height), width, and/or pattern of the active material 2 can be determined first, and then the flexible base material 1 can be subsequently chosen so as to have the necessary characteristics (such as flexibility and/or directionality) that will achieve a precise transformed structure.

In general, varying the amount of active material 2 (e.g., layer width, a layer height, and/or pattern density), while maintaining all other properties without modification, will generally result in the active material 1 having more or less strength or transformation capability. For example, more active material 2 typically results in greater active material strength (i.e., activation and transformation strength or force), but generally results in a slower transformation (i.e., time it takes, upon activation, to reach the final transformed shape). On the other hand, less active material 2 usually results in less strength, but generally results in a faster transformation. Various active materials 2 can be utilized to promote shape transformation or respond to various external stimuli, i.e., active material triggers 4. An important factor when selecting the active material 2 is the amount of expansion or contraction of the active material based on certain triggers 4, and sometimes the intensity of the trigger (i.e., the intensity of the external stimulus). For example, a hydrogel-based material will swell when subject to water. When such a hydrogel-based material is used as the active material 1s, and is disposed onto a flexible base material 1, this swelling effect will cause the flexible base material 1 to curl with the hydrogel active material 2 on the outside of the curl and the flexible base material 1 on the inside (basically the opposite transformation as the one depicted in FIG. 1C).

According to preferred embodiments, activation of the active material 2 results in expansion or contraction. Preferably, the active material 2 is designed to have a differential expansion or contraction (e.g., different coefficients of thermal expansion, different absorption characteristics of electromagnetic energy, etc.) greater or less than that of the flexible base material 1, preferably significantly greater or less than that of the flexible base material. While a small difference in the expansion or contraction properties of the active material 2 vs. the flexible base material 1 can still provide some transformation in shape, such a transformation may be small or even unnoticeable. Thus, it is preferred that the difference in these properties is such that the active material 2 is at least about 20%, 30%, 40%, 50%, 60% 70%, 80%, 90%, and up to 100% (wherein the flexible base material is completely non-reactive) more reactive than the base material 1. Similarly, if the two materials 1, 2 were selected to have roughly equal expansion or contraction, then the combined material 3 would generally not undergo a 3-dimensional transformation according to the present invention, rather, the combined material may, for example, shrink or swell as a whole along a plane. In particular, according to embodiments of the present invention, the exposure of the combined structure 3 causes the active material 2 to respond to a greater extent (e.g., by swelling to a large extent) than the flexible base material 1 (e.g., which may not swell at or, may swell to a relatively small degree, or may even expand). As a result of this difference in response between the flexible base material 1 and the active material 2, the combined structure 3 transforms from its state absent the trigger 4 into a second shape (e.g., by curling). Generally, a greater relative degree of swelling (or particular reaction) between the two materials 1, 2 leads to a greater degree of deformation in the combined structure 3. In addition, the relative stiffness of the flexible base material 1 and the active material 2 affects the extent of distortion in the combined structure 3. For example, a stiffer active material 2 and a softer flexible base material 1 will permit greater deformation. On the other hand, a very soft active material 2 can be inefficient in creating deformation in a combined structure 3 having a flexible base material with relatively greater stiffness. In other words, if the active material 2 is very soft, it may not exert enough force to resist the flexible base material 1, so the combined structure 3 shape will not change. In addition, a thicker active material 2 will cause greater deformation that a thinner active material 2. As such, the selection of active material 2 should be different than the flexible base material 1.

The active material 2 can be disposed onto/within the flexible base material 1 in any manner that forms a strong bond between the active material 2 and flexible base material 1 such that the active material 2 and flexible base material 1 will together transform, as a combined structure 3, into the predetermined shape.

One preferred implementation of disposing active material 2 onto one or more surfaces of the flexible base material 1 is by means of printing, particularly 3D printing. 3D printing has conventionally been used to create static objects and other stable structures, such as prototypes, products, and molds. Three dimensional printers can convert a 3D image, which is typically created with computer-aided design (CAD) software, into a 3D object through the layer-wise addition of material. In the present invention, 3D printing can be used to create, design, and print a custom height, width and pattern of active material 2 on top of the flexible base material 1. According to preferred embodiments, 3D geometric shapes are achieved using computer software loadable from a non-transient computer-readable medium, which can be used to calculate the pattern and design specifications in which the active materials 2 are printed on the flexible base material 1 for subsequent transformation to the precise and predetermined 3D geometric shape. For example, the pattern of the printed active material 2 can be designed by reference to the predetermined 3D geometric shape (transformed shape), and computer software loadable from a non-transient computer-readable medium can be used to calculate the pattern in which the active material 2 is printed for subsequent transformation to the transformed shape.

Any 3D printing technology can suitably be used in the present invention to dispose the desired active materials 2 on the flexible base material 1. One example of such a 3D printing technology includes multi-material three-dimensional (3D) printing technologies, which allow for deposition of material patterns with heterogeneous composition. For example, 3D printed structures can be composed of two or more active materials having particular physical and chemical properties. The Objet® line of 3D printers (Stratasys Ltd., Israel) can be used for the 3D printing of multi-material objects. Such printers are described in U.S. Pat. Nos. 6,569,373; 7,225,045; 7,300,619; and 7,500,846; and U.S. Patent Application Publication Nos. 2013/0073068 and 2013/0040091, each of the teachings of which being incorporated herein by reference in their entireties. The Stratasys® Connex™ multi-material printers provide multi-material Polyjet™ printing of materials having a variety of properties, including rigid and soft plastics and transparent materials, and provide high-resolution control over material deposition.

One of skill in the art will understand that it may be necessary to cure (e.g., polymerize) the 3D printed active material. For example, it will typically be necessary to cure the active material 2 prior to exposure to the active material trigger 4.

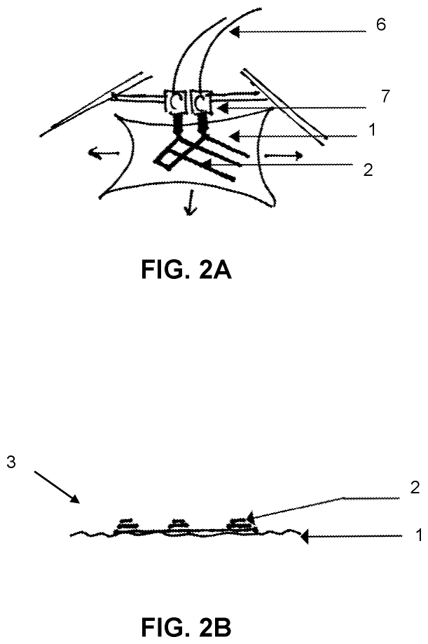

A simplified depiction of 3D printing is shown in FIGS. 2A-2B, in which a printer filament 5 and printer nozzles 6 are positioned so as to deposit the active material 2 onto flexible base material 1. A side view of the printed active material 2 is depicted in FIG. 2B, in which the active material 2 is provided with a particular height “h” and width “w” which is designed and provided so as to contribute to achieving the desired transformed shape.

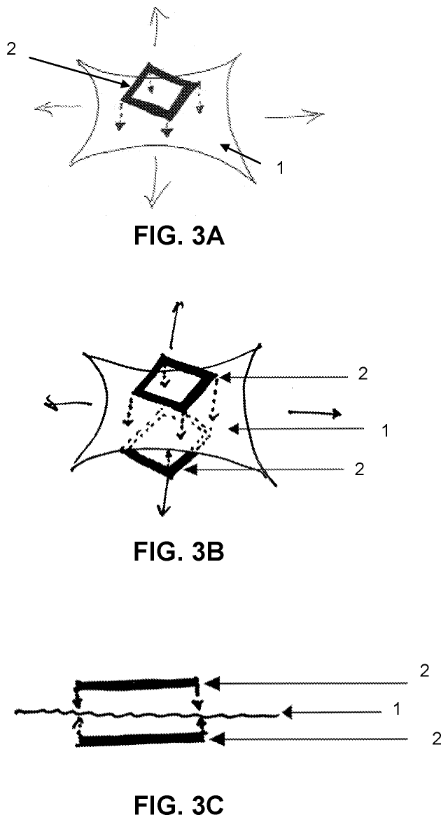

According to further embodiments, the active material 2 is deposited onto the flexible base material 1 through lamination or adhesion. For example, as depicted in FIGS. 3A-3C, one or more active materials 2 are formed into the desired patterns (which may simply be a sheet of material to overlay the entire or a portion of the base material 1) to be deposited onto the stretchable base material 1 (e.g., through laser-cutting, CNC routing, or any other method of forming the desired pattern for subsequent lamination or adhesion). Typically the active material 2 is then laminated or adhered to one surface of the flexible base material 1 as depicted in FIG. 3A. However, in some embodiments, an upper and a lower surface of the flexible base material 1 may have active materials 2 laminated or adhered thereto, resulting in a flexible base material 1 sandwiched between the top and bottom active materials 2. These two active materials 2 may be identical in structure as shown in FIGS. 3B-3C, or there may be a structure on an upper surface than on the lower surface. In addition, the particular materials used as the active materials 2 on the upper and lower surface may be the same or they may be different.

This process of laminating or adhering the physical constraint 2 to the pre-stressed stretchable base material 1 creates a similar transformable material as that formed with 3D printing. While this alternate method allows for quick production of the active material 2 on the flexible base material 1, it can limit the nature of the 3-dimensional structure that can be created since the laser cut or CNC routed laminated sheets cannot be provided with as intricate detail as 3D printed patterns. In particular, 3D printing is particularly beneficial because it allows for a much more complex structures, as well as variable height/width of the deposited active materials and, thus, can provide a user with more control over the final transformed shape. Further, with adhesion, the glue or other material used to adhere the active material 2 to the flexible base material 1 must also be carefully selected because it essentially creates another layer of material having properties that can impact the transformable material. Preferably, thus, glue or other material is selected so that its properties do not interfere with or impact the properties of the flexible base material 1 and the active material 2 (e.g., it can be a very pliable, stretchable, flexible material that will take on any form that is imposed upon it by the flexible base material 1 and the active material 2).

As in the implementations using 3D printing, when using lamination or adhesion, the pattern, width/thickness and material properties of the added laminated or adhered active material 2 will contribute to the resultant manufactured or transformed shape. Also, using either method, multiple layers of materials and different regions of relatively flexible and stiff materials can be deposited to create a complex combined structure 3 based on the desired transformed shape. Further, as with 3D printing, one of skill in the art will understand that it may be necessary to cure (e.g., polymerize) the laminated or adhered active material and any glue or adhesive utilized. For example, any glue or adhesive must be fully cured, and it is generally necessary to cure the active material 2 material prior to exposure of the combined structure 3 to the trigger 4, and prior to transformation of the shape—otherwise, the active material 2 may separate from the flexible base material 1 which may result in the transformed or manufactured shape not being formed properly.

According to further embodiments, the active material 2 may be disposed on the flexible base material 1 by knitting, weaving, stitching, injecting or other processes of material addition. As in the implementations using 3D printing and lamination, the pattern, width/thickness and material properties of the active material 2 will contribute to, in relation to the direction and flexibility/stiffness of the flexible base material 1, will dictate the resultant shape transformation.

According to the present invention, the active material 2 should be sufficiently bonded to the flexible base material 1 to provide a successful transformed shape (i.e., one that achieves the final desired transformed shape and holds the transformed shape as needed). This bonding may be produced by 3D printing materials, such as plastics, with the correct melting temperature and material properties to sufficiently bond with the flexible base material 1. Similar bonding may also be produced with adhesives for a lamination process or by mechanical means of stitching, riveting or other physical connection means. While not being bound by theory, it is believed that the better the active material 1 is bound to the flexible base material 1, the more the flexible base material 1 and the active material 2 will act as a single system and will transform in the correct transformed shape 5.

In addition, according to some embodiments, an active material 2 may be bonded to the flexible base material 1 only along portions of the active material 2. As a simple example, the flexible base material 1 may be a simple rectangular, flat piece of a fabric. The active material 2 may also be a simple rectangular, flat piece of material. If only two opposing edges of the rectangular active material 2 are bonded to the corresponding edges of the rectangular flexible base material 1, then a different resultant transformed shape would result than in two strips of active material 2 were bonded to the corresponding edges of the rectangular flexible base material 1. In particular, using the entire sheet of active material which is selectively bonded, if the active material is activated, the two bonded strips will change the shape of the flexible base material, but the loose (un-bonded) portion of the active material will also play a role in the transformation.

As discussed, the present invention provides active self-transforming materials, wherein the transformation is the result of one or more active material triggers 4. As such, another aspect of the present invention relates to the specific type of trigger 4 that is applied to the combined structure 3. In general, the active material trigger 4 is an external stimulus that is configured to cause a predicted transformation of the combined structure 3 from its natural shape to the transformed shape to exposure of the active material 2 to the external stimulus. If there are no specific limitations as to the environment in which the combined structure 3 is being used, then any type of active material 3 having any related trigger 4 can be used. However, where the combined structure 3 is being designed so as to react to a particular trigger 4, the active material 2 must be selected accordingly.

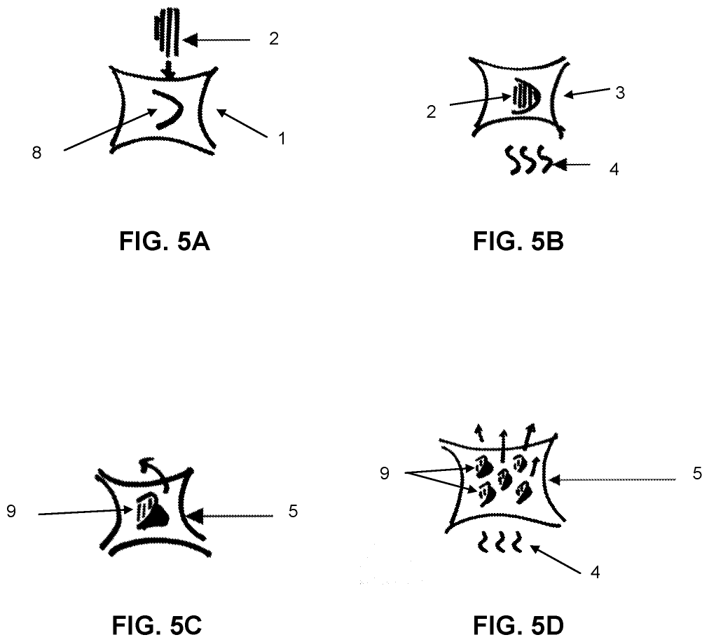

For example, hydrogels can be used for moisture change, nylon or other plastics for temperature change, polystyrene or other plastics for light-based change, etc. Appropriate selection of the active material 2 can, thus, be made based on the type of active material trigger 4. According to one preferred implementation, a plastic-based material, such as Nylon, is disposed as the active material 2 onto a textile flexible base material 1, which causes the resultant combined structure to curl and un-curl in response to heat application (e.g., an increase in body heat). This action can be used to design an article of clothing that forms vents when the wearer's body temperature increases or when the external temperature increases. One depiction of this in in FIGS. 5A-5D. As shown, a flexible base material 1 can be formed with one or more flaps 8 disposed therein. The active material 2 may be disposed on the surface of the flaps 8 (FIG. 5B) to form vents 9. The active material 2 is selected and disposed in such a way that when exposed to the active material trigger 4 (here, heat), the vents 9 lift up and away from (e.g., by curling) the remainder of the flexible base material 1 forming the garment.

Further, a single material or multiple materials can be used simultaneously as the active material 2 to create different transformations based on different triggers 4. For example, both a hydrogel and Nylon can be disposed as active materials on a flexible base material 1 to produce a custom combined structure 3 that can transform one direction when subject to moisture, can then transform in another direction when subject to heat, and can finally transform in a third direction when subject to hot water. Such multiple active materials 2 can be disposed in any desired manner on the flexible base material 1. For example, any number of different active materials maybe provided in multiple layers (e.g., with a first material on a bottom layer and a second material on a top layer) and/or may be provided in separate layers (e.g., with a first material forming a first pattern and a second material forming a second pattern).

In general, the type, amount, and location of the active material trigger 4 (i.e., external stimulus) applied to the combined structure 3 will create different transformation characteristics based on the pattern and amount of active material 2. For example if a minimal amount of heat triggered active material 2 is disposed on only a portion of a flexible base material 1, and then heat is applied to the entire combined structure 3, the resultant transformation will be based on the selective pattern of active material 2. The flexible base material 1 without the active material 2 preferably does not respond to the heat-rather, only the heat triggered active material 2 will shrink and cause local transformation. Conversely, if an entire surface of the flexible base material 1 has a pattern of the heat triggered active material 2 disposed thereon, a very different transformation may occur thank in the previous example if the entire combined structure 3 is subject to heat. For example, a global curling shape would likely emerge rather than local transformation in the previous example. In addition, the heat may be applied in a precise and local pattern on the combined structure 3 so as to provide a local transformation rather than a global transformation—in other words, only a portion of the active material 2 may be exposed to the heat and, thus, activated. This demonstrates that the location of the applied active material trigger 4 can have a direct impact on the type of transformation.

Similarly, varying the amount of activation (i.e., intensity of the trigger/external stimulus) can cause different transformation characteristics. For example, if more heat (or any other trigger) is applied in a short amount of time (as opposed to less heat), this may speed up the transformation, depending on the characteristics of the active material 2. The length of time may also impact the shape transformation, where a longer application of heat (or any other trigger) may produce a different shape by allowing the combined structure 3 to transform more than if the heat was applied only for a short amount of time.

Finally, different types of triggers, in relation to the active material 2, can cause different transformation characteristics. For example, water-activated materials may tend to transform slower and less repeatable than heat-active materials. Light-active materials may tend to react quicker, but could be single-direction (irreversible) whereas a heat-active material may be completely reversible and repeatable.

As such, one or more of the location and type of active material, the type of trigger, the level of external stimuli (i.e., intensity of the trigger), and the duration of exposure to the trigger may be designed specifically with the particular application and environment of use in mind.

The 3-dimensional transformed shape 5, thus, is a result of the careful design of (1) the material property and directionality of flexibility/stiffness of the flexible base material 1, (2) the properties, amount and 2 or 3-dimensional pattern of the active material 2, and (3) the amount, pattern, and duration of active material trigger 4. This relationship can be simplified and easily controlled if, for example, a single flexible base material 1, active material 2 and activation energy are used. This leaves only the pattern and quantity of the deposited active material 2, and thus, the pattern of the active material 2 becomes the “program” for creating precise self-transforming materials. Of course, other features could be maintained constant with others are varied (i.e., the varied features becoming the “program”), depending upon the particular objectives and environment in which the material will be used.

If desired, the combined structure 3 can include one or more additives, such as one or more photoinitiator, surface active agent, stabilizer, and inhibitor. Such additives can be included in the flexible base material 1 and/or the active material 2.

The present invention beneficially allows for precise control over 3-dimensional self-transformations for combined structures 3 including active materials 2. Complex, precise and pre-determined transformed shapes can be achieved such as textile detailing, patterning and fashion/apparel texturing (ripple patterns, tufting, pleating, etc.) or larger repeatable transformations for comfort, custom fit or openings (sinusoidal waves, various degrees of positive and negative curvature, cut/vents, etc.). The present invention offers significant advantages over traditional methods of making complex geometry, curvature or detailing in flat textiles.

In particular, the present invention provides a method capable of producing predictable and unique geometric structures from traditionally passive, flat materials to thereby open up new opportunities for a variety of products and industrial manufacturing processes. By reducing the manual labor, time and skill required to form materials into complex shapes, the present techniques provide significant efficiencies and manufacturing opportunities. Similarly, by introducing a new method for creating highly active self-transforming materials, entirely new products can be imagined that would not have been previously possible. The present invention further offers the ability to develop entirely new forms and complex textile structures that can transform repeatedly based on the environment or supplied energy/trigger.

Further, rather than utilizing conventional techniques, which require stretching and forcing materials around a physical mold, the present invention allows a single sheet of material to self-transform into any arbitrary 2D or 3D structure based on activation energy/trigger. As such, the use of molds can be entirely eliminated, thereby reducing the cost and limitations for a single product type. The present techniques also allow for customizable products to be easily produced and for entirely new types of products to be developed that would previously not have been possible with a subtractive-milled mold.

In addition, new products are also now possible that can self-transform and adapt to the user or the type of use and fluctuating environments. Currently, nearly all products are designed to be static with a single function and fit. For example, shoes and clothing are designed for a single type of use, and do not adapt if the user changes from one climate to another, if they start to run versus walk, if they grow or gain/loose weight, etc. Using the present active self-transforming materials, clothing, shoes, and other items can now be designed to change, for example, to open or close to allow active venting/cooling/heating, transform shape for water proofing or moisture retention, and independently morph for added comfort or structure based on a user's activity. For example, someone might want a loose-fit shirt for everyday use, and may want a tighter-fit shirt when playing sports-using the present transforming materials, one can have a single shirt that provides both desired fits. This can be desirable, for example, when a wearer decides to participate in a sport at the last minute after work, and would otherwise not have the proper clothing to do so. Similarly, a garment may open as the external temperature increases to actively cool the person, or may close when it is a cooler environment. The garment may also open in specific places if the person starts playing a sport or increasing their body temperature. In addition, the transformable materials can provide more a customized fit for apparel and footwear, and can provide complex curvature (i.e. for the body or foot) without darting, patterning or patching material. Thus, entirely new product concepts can be realized with present active self-transforming materials, which are capable of morphing their shape and/or performance based on the user's body, comfort, new design or aesthetic preferences, fluctuating environments and changing activities.

The present active self-transforming materials can also be designed to create dynamic performance increase-including aerodynamics, moisture control, temperature control or other properties which provide highly dynamic complex shapes/textures/patterns that may create a competitive advantage. For example, by controlling the shape and resultant flexibility/stiffness and actuation of the transforming material, a dynamic combined structure surface can transform on an athlete to increase or decrease aerodynamic resistance or breathability for higher performance. Similarly, the present transformable materials can dynamically apply pressure in various points of the body to increase and/or control blood-flow, and form active compression garments for athletic and/or medical benefits. Such transformable materials can also be used to form dynamic support for enhanced strength, walking or other physical maneuvers (i.e., a tunable textile exoskeleton). Likewise, the present transformable materials can provide dynamic apparel or footwear for different environments, dynamic body conditions or varied user performance (e.g., running vs. walking etc.). Using the present transformable materials, environmentally adaptive clothing and footwear can be provided wherein, for example, footwear can be designed to automatically pull together and become more water resistant when exposed to moisture, or to expand and allow more airflow if the foot becomes too hot. The present transformable materials could also be used in providing structures like shoe soles, tires, and other structures provided with a grip-like surface to change their grip in response to moisture (e.g., a shoe sole or tire that can change its tread/grip as it gets wet).

The world of interior design can, likewise, benefit from the present transformable materials. In particular, the materials could be used in forming self-transforming furniture or other interior products that can transform in shape on demand, simply by application of an appropriate trigger. Further, complex and 3-dimensional interior partitions and other wall treatments (e.g., blinds and other window treatments) can be fabricated using the present transformable materials in such a way that they self-transform based on fluctuating environments. For example, blinds or other window treatments can be fabricated of a flexible base material with an active material that is activated by light fluctuations. As such, the blinds or window treatments may be in one position when the lighting conditions are dark, and may automatically change (e.g., the blinds may close) when exposed to light (e.g., either the external light to provide shielding from the sun, or internal light to provide a person in their home at night with the lights on with privacy.

In addition, in any situation where a sensor utilized, in which the sensor detects a change in an environment (e.g., temperature change, change in moisture level, change in electrical energy, exposure to one or more solvents, etc.), the present material can be used as the sensor or in forming the sensor. In particular, upon exposure to the desired change that is to be detected, the present material can change shape in a manner that will alert a person to that change. Likewise, in any situation where a switch is utilized, wherein the switch is activated by changes in the environment by opening or closing (e.g., temperature change, change in moisture level, change in electrical energy, exposure to one or more solvents, etc.), the present material can be used as the sensor. In particular, the material can be provided so as to change shape and function as a switch upon exposure to the applicable change in the environment. Further, in any situation where an actuator utilized, in which the actuator can detect a change in an environment (e.g., temperature change, change in moisture level, change in electrical energy, exposure to one or more solvents, etc.), the present material can be used as the actuator or in forming the actuator. In particular the present material can be formed into a structure such that exposure to one or more trigger causes the actuator to change shape so as to push or pull something to cause actuation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of forming an active self-transformable material comprising:
providing a flexible base material; and
disposing an active material on one or more surfaces of the flexible base material or within the flexible base material in a specific pattern to form a combined structure having a natural shape,
wherein the active material is a material that is reactive to exposure to an external stimulus trigger,
wherein the flexible base material is non-reactive to the external stimulus trigger, minimally reactive to the external stimulus trigger, or reactive to the external stimulus trigger differently than the active material, and
wherein exposure of at least a portion of the specific pattern of the active material to the external stimulus trigger changes the shape of the combined structure from the natural shape into a predetermined 3-dimensional transformed shape.

2. The method of claim 1, wherein the natural shape of the combined structure is a shape of the combined structure absent exposure to the external stimulus trigger.

3. The method of claim 1, wherein disposing the specific pattern of the active material onto the flexible base material comprises 3D printing the active material, laminating or adhering the specific pattern of the active material to flexible base material, or knitting, weaving, stitching, or injecting the active material in the predetermined pattern onto or within the flexible base material.

4. The method of claim 1, wherein the specific pattern further includes particular heights and widths of the active material along the pattern.

5. The method of claim 1, further comprising tailoring one or more properties of the flexible base material and the active material to achieve the predetermined transformed 3-dimensional shape, the one or more properties being selected from a composition of the flexible base material, composition of the active material, a particular shape of the flexible base material, a thickness of the flexible base material, a stiffness of the flexible base material, a flexibility of the flexible base material, a directionality of the flexible base material, a thickness of the flexible base material, a thickness pattern of the active material, a width pattern of the active material, an overall design pattern of the active material, an amount of the active material, and a difference between one or more properties of flexible base material and the active material.

6. The method of claim 1, wherein the external stimulus trigger is selected from one or more solvents, a temperature change, energy, a pressure change, a lighting change, moisture infrared light, visible light, and ultraviolet light, and combinations thereof.

7. The method of claim 1, wherein the flexible base material is a material selected from stretchable and non-stretchable textiles, elastomeric materials, plastics, rubber, leather, animal skin materials, vegan alternatives to animal skin materials, and sheet foam.

8. The method claim 1, wherein the flexible base material is a stretchable or non-stretchable textile selected from the group consisting of cotton, neoprene, jersey, vinyl, velvet, brocade, silk, polyesters, wool, linen, mesh, and polyester-polyurethane copolymers, including elastane, and spandex.

9. The method of claim 1, wherein the active material is a material selected from materials activated by exposure to temperature change, exposure to light change, exposure to solvents, exposure to moisture, exposure to energy, including electrical energy, exposure to infrared light, exposure to visible light, and exposure to ultraviolet light.

10. The method of claim 1, wherein the active material is a material selected from hydrogels, plastics, polyethylene (PE), polyethylene terephthalate (PET), polyvinylidene fluoride (PVDF), thermoplastic polymers, and combinations thereof.

11. The method of claim 1, wherein the active material is reactive to the external stimulus trigger by swelling or shrinking.

12. The method of claim 1, wherein the active material has a thermal expansion modulus that causes the active material to shrink or swell upon exposure to a temperature change.

13. The method of claim 1, wherein the change in the shape of the combined structure from the natural shape into the predetermined 3-dimensional transformed shape is a reversible change.

14. The method of claim 1, wherein the change in the shape of the combined structure from the natural shape into the predetermined 3-dimensional transformed shape is an irreversible change.

15. A method of forming a predetermined 3-dimensional manufactured shape comprising:
providing a flexible base material;
disposing an active material on one or more surfaces of the flexible base material or within the flexible base material in a specific pattern to form a combined structure having a natural shape, wherein the active material is a material that is reactive to exposure to an external stimulus trigger, and wherein the flexible base material is non-reactive to the external stimulus trigger, minimally reactive to the external stimulus trigger, or reactive to the external stimulus trigger differently than the active material; and
exposing at least a portion of the specific pattern of the active material to the external stimulus trigger to cause a change in the shape of the combined structure from the natural shape into the predetermined 3-dimensional manufactured shape.

16. The method of claim 15, wherein exposing at least a portion of the specific pattern of the active material to the external stimulus trigger comprises exposing only a portion of the specific pattern to the external stimulus trigger to achieve a localized change in the shape of the combined structure.

17. The method of claim 15, wherein disposing the specific pattern of the active material onto the flexible base material comprises 3D printing the active material, laminating or adhering the specific pattern of the active material to flexible base material, or knitting, weaving, stitching, or injecting the active material in the predetermined pattern onto or within the flexible base material.

18. The method of claim 15, further comprising tailoring one or more properties of the flexible base material and the active material to achieve the predetermined transformed 3-dimensional shape, the one or more properties being selected from a composition of the flexible base material, composition of the active material, a particular shape of the flexible base material, a thickness of the flexible base material, a stiffness of the flexible base material, a flexibility of the flexible base material, a directionality of the flexible base material, a thickness of the flexible base material, a thickness pattern of the active material, a width pattern of the active material, an overall design pattern of the active material, an amount of the active material, and a difference between one or more properties of flexible base material and the active material.

19. The method of claim 15, wherein the external stimulus trigger is selected from one or more solvents, a temperature change, energy, a pressure change, a lighting change, moisture infrared light, visible light, and ultraviolet light, and combinations thereof.

20. The method of claim 15, wherein the flexible base material is a material selected from stretchable and non-stretchable textiles, elastomeric materials, plastics, rubber, leather, animal skin materials, vegan alternatives to animal skin materials, and sheet foam.

21. The method claim 15, wherein the flexible base material is a stretchable or non-stretchable textile selected from the group consisting of cotton, neoprene, jersey, vinyl, velvet, brocade, silk, polyesters, wool, linen, mesh, and polyester-polyurethane copolymers, including elastane, and spandex.

22. The method of claim 15, wherein the active material is a material selected from materials activated by exposure to temperature change, exposure to light change, exposure to solvents, exposure to moisture, exposure to energy, including electrical energy, exposure to infrared light, exposure to visible light, and exposure to ultraviolet light.

23. The method of claim 15, wherein the active material is a material selected from hydrogels, plastics, polyethylene (PE), polyethylene terephthalate (PET), polyvinylidene fluoride (PVDF), thermoplastic polymers, and combinations thereof.

24. The method of claim 15, wherein the active material is reactive to the external stimulus trigger by swelling or shrinking.

25. The method of claim 15, wherein the active material has a thermal expansion modulus that causes the active material to shrink or swell upon exposure to a temperature change.

26. The method of claim 15, wherein the change in the shape of the combined structure from the natural shape into the predetermined 3-dimensional transformed shape is a reversible change.

27. The method of claim 15, wherein the change in the shape of the combined structure from the natural shape into the predetermined 3-dimensional transformed shape is an irreversible change.

28. The method of claim 15 further comprising, before exposing at least a portion of the specific pattern of the active material to the external stimulus trigger forming the combined structure having a natural shape into a first 3-dimensional structure,
wherein subsequent exposing at least a portion of the specific pattern of the active material to the external stimulus trigger causes a change in natural shape of the combined structure forming the first 3-dimensional structure into the predetermined 3-dimensional manufactured shape.

29. The method of claim 28, wherein the flexible base material is in the form of a generally flat and flexible material having a plurality of flaps disposed therein, wherein the active material is disposed on the plurality of flaps in such a manner that exposing the active material to the external stimulus trigger causes the flaps to lift and form a plurality of air vents, and wherein the predetermined 3-dimensional manufactured shape is the first 3-dimensional structure with the plurality of air vents in a lifted position.

30. The method of claim 29, wherein the external stimulus trigger is a temperature change.
